(19) United States
(12) Patent Application Publication
(10) Pub. No.: US 2025/0140978 A1
(43) Pub. Date: May 1, 2025

(54) BATTERY BOX AND MANUFACTURING METHOD FOR BATTERY BOX

(71) Applicant: Jinko Energy Storage Technology Co., Ltd., Haining (CN)

(72) Inventors: Yadong Liang, Haining (CN); Guochao Chen, Haining (CN); Shaorong Ge, Haining (CN)

(21) Appl. No.: 18/677,783

(22) Filed: May 29, 2024

(30) Foreign Application Priority Data
Oct. 25, 2023 (CN) 202311395032.1
Oct. 25, 2023 (CN) 202322873372.2

(51) Int. Cl. H01M 10/6568; H01M 10/613; H01M 10/653; H01M 50/233; H01M 50/256

(52) U.S. Cl. CPC H01M 10/6568; H01M 10/613; H01M 50/233; H01M 50/256; H01M 10/653

(57) ABSTRACT

A battery box and a manufacturing method for a battery box are provided. The battery box includes at least two welded bottom plates. Each of the bottom plates is provided with a fourth cavity. The fourth cavity is configured to circulate coolant. Each of the bottom plates includes a first side wall welded to the adjacent bottom plate. The first side wall has a set width W₂. The outermost bottom plate includes a second side wall spaced apart from the first side wall. The second side wall has a set width W₃, where 2W₂>W₃. The battery box of the present disclosure can solve the problem of high manufacturing difficulty of the battery box in the prior art due to high structural complexity of the battery box.

### CROSS-REFERENCE TO RELATED APPLICATIONS

This application claims priority to Chinese Patent Application No. 202311395032.1 filed on Oct. 25, 2023, and further claims priority to Chinese Patent Application No. 202322873372.2 filed on Oct. 25, 2023, the entire contents of which are incorporated herein by reference.

### TECHNICAL FIELD

The present disclosure relates to the technical field of energy storage, and in particular, to a battery box and a manufacturing method for a battery box.

### BACKGROUND

An energy storage battery is an essential component for storing electrical energy in a solar photovoltaic power generation system, with a main function of storing electrical energy of the photovoltaic power generation system and supplying power to a load when an amount of sunlight is insufficient, at night, and in emergency situations. The energy storage battery is generally installed inside a battery box. However, the battery box in the prior art has the problem of high manufacturing difficulty due to high structural complexity of the battery box.

### SUMMARY

In view of this, the present disclosure provides a battery box and a manufacturing method for a battery box, so as to help solve the problem of high manufacturing difficulty of the battery box in the prior art due to high structural complexity of the battery box.

In a first aspect, the present disclosure provides a battery box, wherein the battery box includes at least two welded bottom plates, each of the bottom plates being provided with a fourth cavity, the fourth cavity being configured to circulate coolant, each of the bottom plates including a first side wall welded to the adjacent bottom plate, the first side wall having a set width W₂, the outermost bottom plate including a second side wall spaced apart from the first side wall, and the second side wall having a set width W₃, where 2W₂>W₃.

A structural plate located at the bottom of the battery box is configured to fix and support batteries located inside the battery box. The structural plate with a large area is formed by at least two bottom plates with relatively small areas. Each bottom plate is provided with a fourth cavity. The fourth cavity is configured to circulate coolant. In detail, the coolant located outside the battery box flows into the fourth cavity, through heat transfer, the coolant can absorb heat generated by the battery installed on the bottom plate during operation, and the coolant that absorbs the heat flows to the outside of the bottom plate. By reciprocating the coolant in the fourth cavity, the battery is allowed to operate within a normal temperature range, thereby prolonging the service life of the battery. As can be seen from the above content, the bottom plate is used as part of the structural plate of the battery box such that the bottom plate has a function of fixing and supporting the battery, and the fourth cavity provided in the bottom plate may also be configured to circulate the coolant, such that the bottom plate may also be configured to achieve heat dissipation. Compared with a separate structural plate for fixing and supporting the battery and a separate heat dissipation plate for heat dissipation, the bottom plate and the battery box provided in the present disclosure have lower structural complexity, and it is less difficult to manufacture the bottom plate and the battery box. Secondly, since the bottom plate in contact with the battery has an integrated heat dissipation function, a heat transfer path formed is shorter, and the heat of the battery can be quickly transferred to the coolant located in the bottom plate, resulting in higher heat dissipation efficiency. Due to the large area of the structural plate at the bottom of the battery box, if a large-area structural plate is directly manufactured at one time by using the existing manufacturing process, structural strength and dimensional accuracy of the formed structural plate are relatively poor. However, the structural plate at the bottom of the battery box in the present disclosure is formed by welding at least two bottom plates with relatively small areas. In this way, during the manufacturing, at least two bottom plates with relatively small areas may be manufactured first, and structural strength and dimensional accuracy of each bottom plate manufactured with the existing manufacturing process are relatively high. Then, the formed bottom plate is welded to form a bottom structural plate required for the battery box. Structural strength and dimensional accuracy of the formed structural plate are also relatively high, which can better meet an actual use requirement. Each bottom plate includes a first side wall, and the first side wall of each bottom plate is welded to the first side wall of the adjacent bottom plate. That is, the two welded first side walls serve as a connecting structure of the two bottom plates. This welding manner has advantages of high strength and high connection reliability of the connecting structure. The outermost bottom plate further includes a second side wall. The second side wall serves as a structure configured to meet a shape, a size or structural strength of the bottom plate, and the second side wall is not configured to be welded to another bottom plate. The first side wall has a set width W₂, and the second side wall also has a set width W₃, where 2W₂>W₃. In this way, since a sum of the widths W₂ of the two adjacent first side walls is large, during the welding, a width of a meltable connection region between the two adjacent bottom plates is large, a width of a welded structure formed between the two adjacent bottom plates after the welding is larger, structural strength of the welded structure between the two adjacent bottom plates is higher, and a possibility of a structural problem such as cracking, breakage, or bending of the welded structure between the two adjacent bottom plates is low. Accordingly, the structural plate formed by welding at least two bottom plates has higher operational reliability.

In some embodiments, 7 mm≤W₂≤10 mm, or 3 mm≤W₃≤8 mm.

In some embodiments, the bottom plate further includes a second top wall and a second bottom wall, the second top wall being connected to the second bottom wall through the first side wall and the second side wall, the second top wall, the first side wall, and the second bottom wall are at least part of a structure configured to define the fourth cavity, and a first chamfered portion is included at a connection between a side of any one of the first side walls facing away from the adjacent first side wall and the corresponding second top wall, and/or a second chamfered portion is included at a connection between a side of any one of the first side walls facing away from the adjacent first side wall and the corresponding second bottom wall.

In some embodiments, the first chamfered portion has a chamfered circle structure, and the first chamfered portion has a set radius R₁, where 1 mm≤R₁≤3 mm; and/or the second chamfered portion has a chamfered circle structure, and the second chamfered portion has a set radius R₂, where 1 mm≤R₂≤3 mm.

In some embodiments, there is a set height H₂ between the second top wall and the second bottom wall, where 5 mm≤H₂<8 mm.

In some embodiments, the bottom plate further includes a support portion located in the fourth cavity, and the second bottom wall is connected to the second top wall through the support portion.

In some embodiments, the support portion has a set height H₃, where 5 mm≤H₃≤8 mm, and/or the support portion has a set width W₄, where 3 mm≤W₄≤5 mm.

In some embodiments, a third chamfered portion is included at a connection between the support portion and the second top wall, and/or a fourth chamfered portion is included at a connection between the support portion and the second bottom wall.

In some embodiments, the third chamfered portion has a chamfered circle structure,

and the third chamfered portion has a set radius R₃, where 1 mm<R₃<3 mm; and/or the fourth chamfered portion has a chamfered circle structure, and the fourth chamfered portion has a set radius R₄, where 1 mm≤R₄≤3 mm.

In some embodiments, the support portion has a plate-like structure, and the fourth cavity is separated by the support portion to form at least two parallel and communicated flow channels.

In some embodiments, a cross section of the flow channel is in a shape of a rectangle, a circle, a semicircle, an ellipse, or a hexagon.

In some embodiments, the bottom plate further includes at least two partitions located in a same flow channel, the partition being parallel to the plate-like support portion, and the partitions located in the same flow channel being spaced apart along a flow guiding direction of the flow channel.

In some embodiments, the bottom plates are distributed along a width direction or a length direction of the battery box, the fourth cavities of the bottom plates are in communication with each other, one of the outermost bottom plates is provided with a liquid inlet, and the other of the outermost bottom plates is provided with a liquid outlet.

In some embodiments, the battery box further includes a liquid inlet connecting pipe and a liquid outlet connecting pipe, the liquid inlet connecting pipe being in communication with the liquid inlet, and the liquid inlet connecting pipe being sealingly connected to the bottom plate provided with the liquid inlet; the liquid outlet connecting pipe being in communication with the liquid outlet, and the liquid outlet connecting pipe being sealingly connected to the bottom plate provided with the liquid outlet; and the liquid inlet connecting pipe and the liquid outlet connecting pipe being configured to be in communication with corresponding external flow guiding pipes.

In some embodiments, the bottom plate is provided with a fifth opening in communication with the fourth cavity, and the battery box further includes a first blocking member blocking the fifth opening.

In some embodiments, the battery box further includes a side plate, the bottom plates are distributed along a width direction or a length direction of the battery box, and the outermost bottom plate and the side plate are integrally formed or welded; and the side plate is provided with an inwardly concave sliding groove, the sliding groove is configured to be in sliding fit with a slide rail, and a side wall of the side plate configured to define the sliding groove is provided with a hoisting hole, the hoisting hole being configured to be passed through by a hook, such that the side plate is configured to connect with the hook.

The side plate of the battery box in the present disclosure may be provided with the inwardly concave sliding groove, a fixed apparatus configured to store the battery box may include the slide rail, and the sliding groove may be in sliding fit with the slide rail. The assembly manner facilitates rapid installation of the battery box to the fixed apparatus in a sliding manner, and has high assembly efficiency. Certainly, the assembly manner also facilitates rapid detachment of the battery box from the fixed apparatus in a sliding manner, and has high disassembly efficiency. The side plate of the battery box is further provided with a hoisting hole. The hoisting hole is configured to be passed through by a hook of a hoisting apparatus (an apparatus such as a crane, an overhead crane, or a hoist) to connect the side plate to the hook, such that the hook of the hoisting apparatus can quickly move the battery box. For example, the hook may move the battery box to a position where the sliding groove and the slide rail are aligned such that the sliding groove and the slide rail are in sliding fit, or the hook may move the battery box from the fixed apparatus to another position. Since the hoisting hole is provided in the side plate to define the side wall of the sliding groove, structural compactness between the sliding groove and the hoisting hole is higher. A dimension of a structure in the side plate configured to arrange the sliding groove and the hoisting hole is relatively small. When dimensions in other directions are the same, the side plate has a relatively small volume, and the battery box takes up relatively little space in the fixed apparatus, such that a relatively large number of battery boxes can be stored inside the space of the fixed apparatus, resulting in a high loading rate. Correspondingly, the side plate has a relatively small weight, and transportation of the battery box consumes less energy.

In some embodiments, the sliding groove is provided on an outer side wall of the side plate arranged along a height direction of the battery box, and a top wall of the side plate configured to define the sliding groove is provided with the hoisting hole.

In some embodiments, a top of the side plate is further provided with a first cavity, the first cavity being in communication with the sliding groove through the hoisting hole, and the first cavity being configured to accommodate at least part of the hook.

In some embodiments, a second cavity is further provided on a side of the side plate facing away from the sliding groove, and the side plate is further provided with a first opening, the first opening being in communication with the hoisting hole, the second cavity being in communication with the sliding groove through the first opening, and the second cavity being in communication with the first cavity through the first opening.

In some embodiments, a third cavity is further provided at a bottom of the side plate, and the side plate is provided with a second opening, the second opening being in communication with the first opening, the second opening being further in communication with the sliding groove, the third cavity being in communication with the second cavity through the second opening, and the third cavity being in communication with the sliding groove through the second opening.

In some embodiments, the outer side wall of the side plate is provided with a third opening, the third opening being in communication with the second opening, and the third opening being configured to avoid a bending portion outer arc surface of the hook.

In some embodiments, the side plate includes an I-shaped rib to separate and form the first cavity, the second cavity, the third cavity, and the sliding groove, and the hoisting hole, the first opening, and the second opening are provided in the I-shaped rib.

In some embodiments, the outer side wall of the side plate is provided with a fourth opening, the fourth opening being in communication with the hoisting hole, and the fourth opening being configured to avoid a bending portion inner arc surface of the hook.

In some embodiments, the sliding groove has a set width W₁, where 10 mm≤W1≤15 mm, and/or the sliding groove has a set depth H₁, where 8 mm≤H1≤12 mm.

In a second aspect of the present disclosure, a manufacturing method for a battery box is provided, including:

step S1: manufacturing, by using an integrated molding process, the side plate and the bottom plate connected to each other; and

step S2: welding at least two bottom plates by using a friction welding process.

The outermost bottom plate and the side plate connected to each other are manufactured by using the integrated molding process. The integrated molding process has advantages of reducing a number of manufactured molds, improving manufacturing efficiency, and improving structural strength and dimensional accuracy between the outermost bottom plate and the side plate. The integrated molding process may be a casting process, an extrusion molding process, or an injection molding process. First side walls of the at least two bottom plates are welded by using the friction welding process. In detail, a temperature of the first side wall of the bottom plate is increased by high-speed friction until at least part of the first side wall melts, molten portions of the first side walls of the two bottom plates are then welded, and after the first side walls are cooled, a welded structure is formed between the first side walls of the two bottom plates. Since no other material is required to assist the welding during the welding, the material of the welded structure between the first side walls of the two bottom plates is the same as that of the bottom plate, that is, structural strength of the welded structure between the first side walls of the two bottom plates is the same as that of the bottom plate, and the formed structural plate located at the bottom of the battery box has higher operational reliability. The first side walls of the two bottom plates may rub against each other at a high speed, or curved side walls of a high-speed rotating cylinder may be used to simultaneously rub the first side walls of the two bottom plates until at least part of the first side walls of the two bottom plates are molten, and then molten portions of the first side walls of the two bottom plates are welded.

### BRIEF DESCRIPTION OF DRAWINGS

In order to more clearly illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a schematic diagram of a three-dimensional structure of a battery box according to some embodiments of the present disclosure;

FIG. 2 is a schematic diagram of an exploded structure of the battery box in FIG. 1;

FIG. 3 is a partial schematic enlarged view of Part A in FIG. 2;

FIG. 4 is a schematic structural diagram of a bottom plate and a side plate;

FIG. 5 is a partial schematic enlarged view of Part B in FIG. 4;

FIG. 6 is a schematic structural diagram of a hook according to some embodiments;

FIG. 7 is a sectional view of a bottom plate and a side plate in FIG. 2 taken along a direction C-C;

FIG. 8 is a partial schematic enlarged view of Part D in FIG. 7;

FIG. 9 is a schematic structural diagram of an I-shaped rib in FIG. 8;

FIG. 10 is a schematic structural diagram of part E in FIG. 7;

FIG. 11 is a sectional view of a bottom plate, a first blocking member, and a second blocking member in FIG. 2 taken along a direction F-F;

FIG. 12 is a schematic diagram of an exploded structure of two bottom plates;

FIG. 13 is a schematic diagram of an exploded structure of three bottom plates;

FIG. 14 is a partial schematic enlarged view of Part G in FIG. 12;

FIG. 15 is a schematic structural diagram of the first blocking member according to some embodiments;

FIG. 16 is a schematic structural diagram of the first blocking member according to some other embodiments;

FIG. 17 is a partial schematic enlarged view of Part H in FIG. 12;

FIG. 18 is a schematic structural diagram of the second blocking member according to some embodiments; and

FIG. 19 is a flowchart of a manufacturing method for a battery box according to some embodiments of the present disclosure.

10: battery box;
   1: side plate;
      1a: outer side wall;
      1b: top;
      1c: bottom;
      1d: I-shaped rib;
      11: sliding groove;
         111: first top wall;
         112: inner side wall;
         113: first bottom wall;
      12: hoisting hole;
      13: first cavity;
      14: first opening;
      15: second cavity;
      16: second opening;
      17: third cavity;
      18: third opening;
         181: first chamfered circle structure;
      19: fourth opening;
         191: second chamfered circle structure;
   2: bottom plate;
      21a: fourth cavity;
         211: flow channel;
      21b: fifth cavity;
      22a: first side wall;
         221: first chamfered portion;
         222: second chamfered portion;
      22b: second side wall;
      22c: support portion;
         223: third chamfered portion;
         224: fourth chamfered portion;
      22d: partition;
      22e: third side wall;
      23a: second top wall;
      23b: second bottom wall;
      24a: liquid inlet;
      24b: liquid outlet;
      25a: fifth opening;
      25b: sixth opening;
      25c: seventh opening;
      26: first through hole;
   3: front plate;
   4: back plate;
   5: upper cover;
   6: liquid inlet connecting pipe;
   7: liquid outlet connecting pipe;
   8: first blocking member;
      81: protruding portion;
      82: interval space;
   9: second blocking member;
      91: second through hole;
20: hook;
   201: bending portion outer arc surface;
   202: bending portion inner arc surface.

### DESCRIPTION OF EMBODIMENTS

In order to better understand the technical solution of the present disclosure, some embodiments of the present disclosure will be described in detail below with reference to the accompanying drawings.

It should be clear that the described embodiments are only some of rather than all of the embodiments of the present disclosure. Based on the embodiments in the present disclosure, all other embodiments obtained by those of ordinary skill in the art without making creative efforts fall within the protection scope of the present disclosure.

The terms used in the embodiments of the present disclosure are only for the purpose of describing specific embodiments and are not intended to limit the present disclosure. As used in the embodiments of the present disclosure and the appended claims, the singular forms of “a/an”, “one”, and “the” are intended to include plural forms, unless otherwise clearly specified in the context.

It is to be understood that the term “and/or” used herein describes an association relationship between associated objects and represents that three relationships may exist. For example, A and/or B may represent the following three cases: only A exists, both A and B exist, and only B exists. In addition, the character “/” generally indicates an “or” relationship between the associated objects.

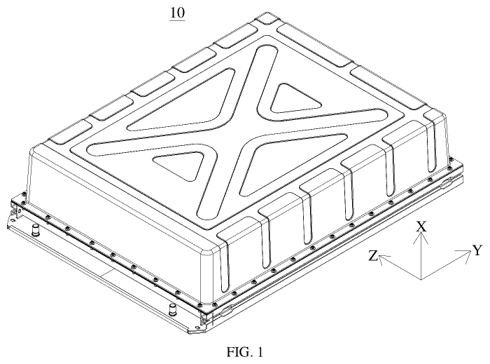

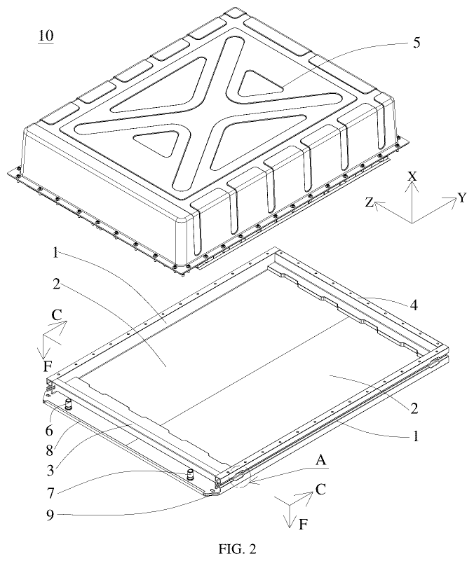

Referring to FIG. 1, in a first aspect of some embodiments of the present disclosure, a battery box 10 is provided. Interior of the battery box is configured to store batteries (not shown), and the battery box is configured to protect the batteries. In actual use, the battery box may be stored in a fixed apparatus such as a bracket, box, or cabinet. Referring to FIG. 2, the battery box 10 includes a side plate 1, a bottom plate 2, a front plate 3, a back plate 4, and an upper cover 5. Two side plates 1 are connected to the bottom plate 2, and the two side plates 1 are arranged opposite to each other. The front plate 3 is connected to the bottom plate 2, the back plate 4 is connected to the bottom plate 2, and the front plate 3 and the back plate 4 are arranged opposite to each other. At least two of the side plate 1, the front plate 3, and the back plate 4 are connected to the upper cover 5. The side plate 1, the bottom plate 2, the front plate 3, the back plate 4, and the upper cover 5 define a space to accommodate the battery. A structure of the side plate 1 is first introduced in the following, followed by a structure of the bottom plate 2. Directions X, Y, and Z described herein are pairwise perpendicular. The dotted lines in the drawings herein are structural boundaries.

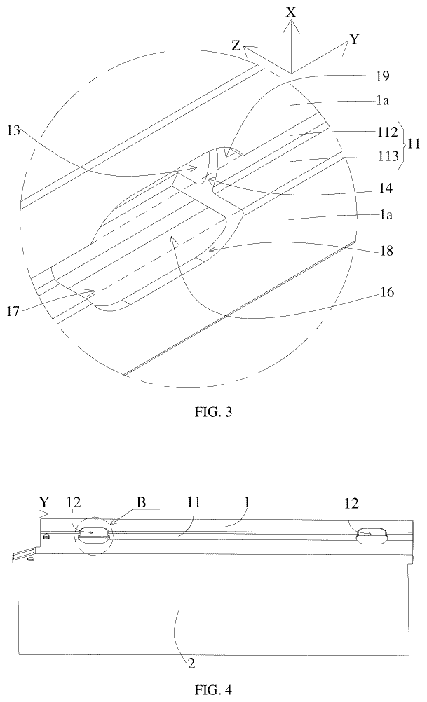

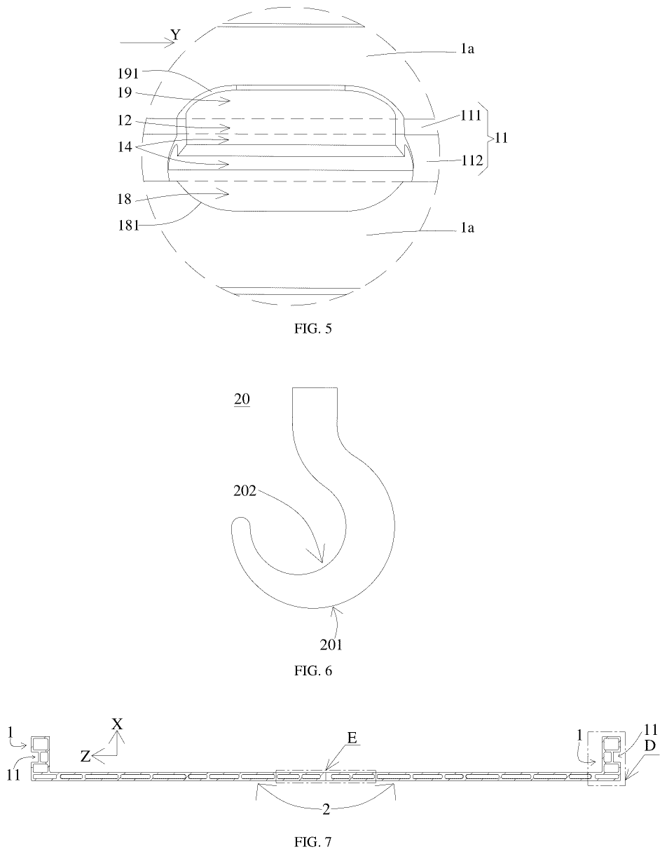

Referring to FIG. 3, the side plate 1 is provided with an sliding groove 11 that is inwardly concaved, and the sliding groove 11 is configured to be in sliding fit with a slide rail (not shown). Referring to FIG. 4 to FIG. 5, a side wall of the side plate 1 configured to define the sliding groove 11 is provided with a hoisting hole 12, and the hoisting hole 12 is configured to be passed through by a hook 20 as shown in FIG. 6, such that the side plate 1 is configured to connect with the hook 20.

Referring to FIG. 3, the side plate 1 of the battery box 10 may be provided with the inwardly concave sliding groove 11, a fixed apparatus (not shown) configured to store the battery box 10 may include the slide rail, and the sliding groove 11 may be in sliding fit with the slide rail. The assembly manner facilitates rapid installation of the battery box 10 to the fixed apparatus in a sliding manner, and has high assembly efficiency. Certainly, the assembly manner also facilitates rapid detachment of the battery box 10 from the fixed apparatus in a sliding manner, and has high disassembly efficiency. Referring to FIG. 4 to FIG. 5, the side plate 1 of the battery box 10 is further provided with a hoisting hole 12. The hoisting hole 12 is configured to be passed through by a hook 20 (as shown in FIG. 6) of a hoisting apparatus (an apparatus such as a crane, an overhead crane, or a hoist) to connect the side plate 1 to the hook 20, such that the hook 20 of the hoisting apparatus can quickly move the battery box 10. For example, the hook 20 may move the battery box 10 to a position where the sliding groove 11 and the slide rail are aligned such that the sliding groove 11 and the slide rail are in sliding fit, or the hook 20 may move the battery box 10 from the fixed apparatus to another position. Since the hoisting hole 12 is provided in the side plate 1 to define the side wall of the sliding groove 11, structural compactness between the sliding groove 11 and the hoisting hole 12 is higher. A dimension (e.g., a dimension along the direction X) of a structure in the side plate 1 configured to arrange the sliding groove 11 and the hoisting hole 12 is relatively small. When dimensions in other directions (e.g., the direction Z and the direction Y) are the same, the side plate 1 has a relatively small volume, and the battery box 10 takes up relatively little space in the fixed apparatus, such that a relatively large number of battery boxes 10 can be stored inside the space of the fixed apparatus, resulting in a high loading rate. Correspondingly, the side plate 1 has a relatively small weight, and transportation of the battery box 10 consumes less energy.

Referring to FIG. 4, the sliding groove 11 may be provided along a length direction (a direction parallel to the direction Y) of the side plate 1.

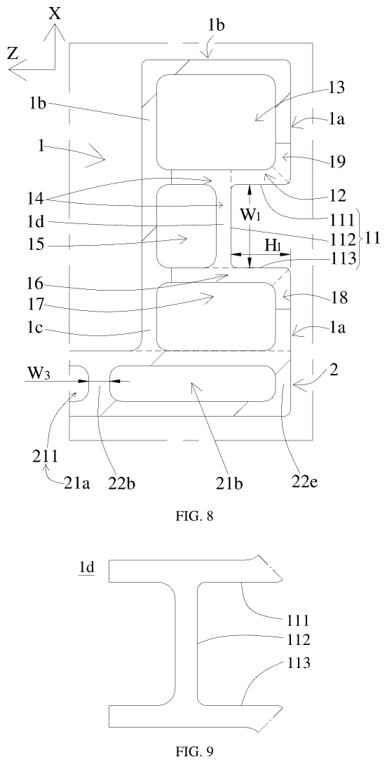

In addition, referring to FIG. 7 to FIG. 8, a cross section of the sliding groove 11 perpendicular to the direction Y may be in a shape of a polygon such as a rectangle or an isosceles trapezoid.

Moreover, the shape and the number of the hoisting hole 12 are not limited in some embodiments of the present disclosure.

In some embodiments, referring to FIG. 8, the sliding groove 11 is provided on an outer side wall 1a of the side plate 1 arranged along a height direction (a direction parallel to the direction X) of the battery box 10. Correspondingly, the slide rail of the fixed apparatus (not shown) is also provided on a side wall structure arranged along a height direction (a direction parallel to the direction X) of the fixed apparatus. In this way, a structure in the fixed apparatus configured to be in sliding fit with the battery box 10 is relatively simple. Since the outer side wall 1a belongs to a structure of the battery box 10 from a common perspective, the sliding groove 11 is easily observed by a user, such that the user can quickly and accurately make the sliding groove 11 in sliding fit with the slide rail. Similarly, the hoisting hole 12 is also easily observed by the user, such that the user can quickly and accurately pass the hook 20 through the hoisting hole 12. Therefore, the above structural arrangement can improve assembly efficiency and assembly accuracy of the battery box 10. The hoisting hole 12 is provided in a top wall 111 of the side plate 1 configured to define the sliding groove 11. Under gravity of the battery box 10, the hook 20 is not easily detached from the hoisting hole 12. Therefore, the connection between the battery box 10 and the hook 20 is highly reliable.

In other embodiments (not shown), a bottom wall of the side plate 1 may be provided with the sliding groove 11 and the hoisting hole 12. The following content is mainly based on an example in which the outer side wall 1a of the side plate 1 is provided with the sliding groove 11 and the hoisting hole 12.

In some embodiments, referring to FIG. 8, a top 1b of the side plate 1 is further provided with a first cavity 13, the first cavity 13 is in communication with the sliding groove 11 through the hoisting hole 12, and the first cavity 13 is configured to accommodate at least part of the hook 20.

A partial structure of the hook 20 shown in FIG. 6 may be moved into the first cavity 13 through the sliding groove 11 and the hoisting hole 12 shown in FIG. 8, such that the hook 20 can be connected to the side plate 1. In this way, there is relatively large space inside the side plate 1 to accommodate the partial structure of the hook 20, there are many positions in an internal structure of the side plate 1 to connect to the hook 20, there is a large area in the internal structure of the side plate 1 to connect to the hook 20, and the position connecting to the hook 20 in the internal structure of the side plate 1 is located on an inner side of the side plate 1. Correspondingly, a length or volume of the structure in the hook 20 located inside the side plate 1 may be relatively large, and structural strength of the hook 20 is relatively high, such that reliability of the connection between the side plate 1 and the hook 20 is relatively high. The arrangement of the first cavity 13 also makes the weight 1 of the battery box 10 relatively small, and transportation of the battery box 10 also consumes less energy.

Referring to FIG. 8, the first cavity 13 may be provided along the length direction (the direction parallel to the direction Y) of the side plate 1.

In addition, referring to FIG. 8, a cross section of the first cavity 13 perpendicular to the direction Y may be in a shape of a polygon such as a rectangle.

In some embodiments, referring to FIG. 8, a second cavity 15 is further provided on a side of the side plate 1 facing away from the sliding groove 11, the side plate 1 is further provided with a first opening 14, the first opening 14 is in communication with the hoisting hole 12, the second cavity 15 is in communication with the sliding groove 11 through the first opening 14, and the second cavity 15 is in communication with the first cavity 13 through the first opening 14.

A partial structure of the hook 20 as shown in FIG. 6 may be located in the first opening 14 and the second cavity 15 as shown in FIG. 8. In this way, there is larger space inside the side plate 1 to accommodate the partial structure of the hook 20, there are more positions in the internal structure of the side plate 1 to connect with the hook 20, and there is a larger area in the internal structure of the side plate 1 to connect with the hook 20. Correspondingly, the length or volume of the structure in the hook 20 located inside the side plate 1 may be larger, and the structural strength of the hook 20 is higher, such that the reliability of the connection between the side plate 1 and the hook 20 is higher. The arrangement of the second cavity 15 makes the weight 1 of the battery box 10 smaller, and the transportation of the battery box 10 also consumes less energy.

Referring to FIG. 8, the second cavity 15 may be provided along the length direction (the direction parallel to the direction Y) of the side plate 1.

In addition, referring to FIG. 8, a cross section of the second cavity 15 perpendicular to the direction Y may be in a shape of a polygon such as a rectangle.

In some embodiments, referring to FIG. 8, a third cavity 17 is further provided at a bottom 1c of the side plate 1, the side plate 1 is provided with a second opening 16, the second opening 16 is in communication with the first opening 14, the second opening 16 is further in communication with the sliding groove 11, the third cavity 17 is in communication with the second cavity 15 through the second opening 16, and the third cavity 17 is in communication with the sliding groove 11 through the second opening 16.

A partial structure of the hook 20 as shown in FIG. 6 may be located in the second opening 16 and the third cavity 17 as shown in FIG. 8. In this way, there is even more space inside the side plate 1 to accommodate the partial structure of the hook 20, there are even more positions in the internal structure of the side plate 1 to connect to the hook 20, and there is an even larger area in the internal structure of the side plate 1 to connect to the hook 20. Correspondingly, the length or volume of the structure in the hook 20 located inside the side plate 1 is even larger, and the structural strength of the hook 20 is even higher, such that the reliability of the connection between the side plate 1 and the hook 20 is even higher. The arrangement of the third cavity 17 makes the weight 1 of the battery box 10 even smaller, and the transportation of the battery box 10 consumes even less energy.

Referring to FIG. 8, the third cavity 17 may be provided along the length direction (the direction parallel to the direction Y) of the side plate 1.

In addition, referring to FIG. 8, a cross section of the third cavity 17 perpendicular to the direction Y may be in a shape of a polygon such as a rectangle.

In some embodiments, referring to FIG. 8, the outer side wall 1a of the side plate 1 is provided with a third opening 18, the third opening 18 is in communication with the second opening 16, and the third opening 18 is configured to avoid a bending portion outer arc surface 201 of the hook 20 as shown in FIG. 6.

At least part of the bending portion outer arc surface 201 of the hook 20 as shown in FIG. 6 may be moved to the sliding groove 11 or other internal space of the side plate 1 via the third opening 18 as shown in FIG. 8, thereby facilitating the connection between the partial structure of the hook 20 and the internal structure of the side plate 1. The arrangement of the third opening 18 can reduce a possibility of structural jamming of the hook 20 and the side plate 1 during the connection, and facilitate the user to quickly connect the hook 20 and the side plate 1.

Referring to FIG. 5, a surface of the outer side wall 1a of the side plate 1 configured to define the third opening 18 includes a first chamfered circle structure 181. The arrangement of the first chamfered circle structure 181 may reduce stress concentration of the structure configured to form the third opening 18 in the side plate 1. Therefore, the structure configured to form the third opening 18 in the side plate 1 is less likely to have cracking problems.

In addition, a shape and an area of the third opening 18 are not limited in some embodiments of the present disclosure.

In some embodiments, referring to FIG. 8, the side plate 1 includes an I-shaped rib 1d to separate and form the first cavity 13, the second cavity 15, the third cavity 17, and the sliding groove 11. In this way, the weight of the side plate 1 is relatively small, structural strength of the side plate 1 is high, and the side plate 1 is less likely to have structural problems such as bending deformation. The hoisting hole 12, the first opening 14, and the second opening 16 are provided in the I-shaped rib 1d, to form interconnection between the sliding groove 11, the hoisting hole 12, the first cavity 13, the first opening 14, the second cavity 15, the second opening 16, and the third cavity 17, such that a partial structure of the hook 20 can be located in the sliding groove 11, the hoisting hole 12, the first cavity 13, the first opening 14, the second cavity 15, the second opening 16, and the third cavity 17 respectively, thereby achieving a technical effect of improving the reliability of the connection between the side plate 1 and the hook 20 in the above content. Details are not described herein again.

Referring to FIG. 8, one part of the first opening 14 is provided in a structure in the side plate 1 between the first cavity 13 and the second cavity 15, and the other part of the first opening 14 is provided in a structure in the side plate 1 between the second cavity 15 and the sliding groove 11.

In addition, referring to FIG. 9, the I-shaped rib 1d includes a first top wall 111, an inner side wall 112, and a first bottom wall 113 configured to define the sliding groove 11. The first top wall 111 is configured to separate the sliding groove 11 from the first cavity 13, the inner side wall 112 is configured to separate the sliding groove 11 from the second cavity 15, and the first bottom wall 113 is configured to separate the sliding groove 11 from the third cavity 17.

In some embodiments, referring to FIG. 8, the outer side wall 1a of the side plate 1 is provided with a fourth opening 19, the fourth opening 19 is in communication with the hoisting hole 12, and the fourth opening 19 is configured to avoid a bending portion inner arc surface 202 of the hook 20 as shown in FIG. 6.

At least part of the bending portion inner arc surface 202 of the hook 20 as shown in FIG. 6 may be moved to the sliding groove 11 or other internal space of the side plate 1 via the fourth opening 19 as shown in FIG. 8, thereby facilitating the connection between the partial structure of the hook 20 and the internal structure of the side plate 1. The arrangement of the fourth opening 19 can reduce a possibility of structural jamming of the hook 20 and the side plate 1 during the connection, and facilitate the user to quickly connect the hook 20 and the side plate 1.

Referring to FIG. 5, a surface of the outer side wall 1a of the side plate 1 configured to define the fourth opening 19 includes a second chamfered circle structure 191. The arrangement of the second chamfered circle structure 191 may reduce stress concentration of the structure configured to form the fourth opening 19 in the side plate 1. Therefore, the structure configured to form the fourth opening 19 in the side plate 1 is less likely to have cracking problems.

The numbers of the first opening 14, the second opening 16, the third opening 18, and the fourth opening 19 above are the same as the number of the hoisting hole 12. That is, each hoisting hole 12 corresponds to the first opening 14, the second opening 16, the third opening 18, and the fourth opening 19.

In some embodiments, referring to FIG. 8, the sliding groove 11 has a set width W₁ (a dimension along the direction X), where 10 mm≤W₁≤15 mm. W1 may be, for example, 10mm, 11 mm, 12 mm, 13 mm, 14 mm, or 15 mm.

Referring to FIG. 8, if W₁ is less than 10 mm, the width W₁ of the sliding groove 11 is smaller. Accordingly, a width of the slide rail of the fixed apparatus (not shown) is also smaller, and structural strength of the slide rail is lower, making the connection between the battery box 10 and the fixed apparatus less reliable. If the width W₁ of the sliding groove 11 is greater than 15 mm, the width W₁ of the sliding groove 11 is greater, a height (a dimension along the direction X) of the side plate 1 is larger, and a volume of the side plate 1 is larger, such that a single battery box 10 occupies more space in the fixed apparatus. The number of battery boxes 10 stored in the fixed apparatus is smaller, that is, a loading rate is smaller. A weight of the side plate 1 is also larger, and the transportation of the battery box 10 consumes more energy. Therefore, the width W₁ of the sliding groove 11 is better within the range of 10 mm to 15 mm.

In some embodiments, referring to FIG. 8, the sliding groove 11 has a set depth H₁(a dimension along the direction Z), where 8 mm≤H₁≤12 mm. H₁ may be, for example, 8 mm, 9 mm, 10 mm, 11 mm, or 12 mm.

Referring to FIG. 8, if H₁ is less than 8 mm, the depth H₁ of the sliding groove 11 is smaller, the sliding groove 11 has less space to accommodate the slide rail of the fixed apparatus (not shown), the slide rail is easily detached from the sliding groove 11, and the sliding fit between the sliding groove 11 and the slide rail is prone to failure. That is, the connection between the battery box 10 and the fixed apparatus is prone to failure. If H₁ is greater than 12 mm, the depth H₁ of the sliding groove 11 is greater, the structural strength of the side plate 1 is lower, and the side plate 1 is prone to structural problems such as deformation. Therefore, the depth H₁ of the sliding groove 11 is better within the range of 8 mm to 12 mm.

The structure of the bottom plate 2 is introduced in the following.

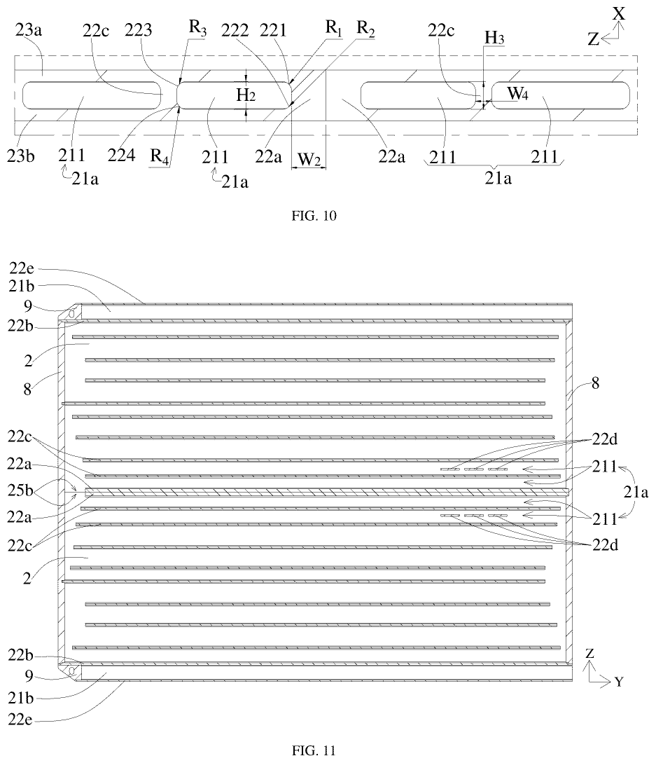

Referring to FIG. 2, a structural plate located at the bottom of the battery box 10 is configured to fix and support batteries (not shown) located inside the battery box 10. The structural plate with a large area includes at least two bottom plates 2 with relatively small areas. Referring to FIG. 10 to FIG. 11, each bottom plate 2 is provided with a fourth cavity 21a, and the fourth cavity 21a is configured to circulate coolant (not shown). In detail, the coolant located outside the battery box 10 flows into the fourth cavity 21a, through heat transfer, the coolant can absorb heat generated by the battery (not shown) installed on the bottom plate 2 during operation, and the coolant that absorbs the heat flows to the outside of the bottom plate 2. By reciprocating the coolant in the fourth cavity 21a, the battery is allowed to operate within a normal temperature range, thereby prolonging the service life of the battery. As can be seen from the above content, the bottom plate 2 is used as part of the structural plate of the battery box 10 such that the bottom plate 2 has a function of fixing and supporting the battery, and the fourth cavity 21a provided in the bottom plate 2 may also be configured to circulate the coolant, such that the bottom plate 2 may also be configured to achieve heat dissipation. Compared with a separate structural plate for fixing and supporting the battery and a separate heat dissipation plate for heat dissipation, the bottom plate 2 and the battery box 10 provided in the present disclosure have lower structural complexity, and it is less difficult to manufacture the bottom plate 2 and the battery box 10. Secondly, since the bottom plate 2 in contact with the battery has an integrated heat dissipation function, a heat transfer path formed is shorter, and the heat of the battery can be quickly transferred to the coolant located in the bottom plate 2, resulting in higher heat dissipation efficiency. Due to the large area of the structural plate at the bottom of the battery box 10, if a large-area structural plate is directly manufactured at one time by using the existing manufacturing process, structural strength and dimensional accuracy of the formed structural plate are relatively poor. However, the structural plate at the bottom of the battery box 10 in the present disclosure is formed by welding at least two bottom plates 2 with relatively small areas. In this way, during the manufacturing, at least two bottom plates 2 with relatively small areas may be manufactured first, and structural strength and dimensional accuracy of each bottom plate 2 manufactured with the existing manufacturing process are relatively high. Then, the formed bottom plate 2 is welded to form a bottom structural plate required for the battery box 10. Structural strength and dimensional accuracy of the formed structural plate are also relatively high, which can better meet an actual use requirement. Each bottom plate 2 includes a first side wall 22a, and the first side wall 22a of each bottom plate 2 is welded to the first side wall 22a of the adjacent bottom plate 2. That is, the two welded first side walls 22a serve as a connecting structure of the two bottom plates 2. This welding manner has advantages of high strength and high connection reliability of the connecting structure. Referring to FIG. 8, the outermost bottom plate 2 further includes a second side wall 22b. The second side wall 22b serves as a structure configured to meet a shape, a size or structural strength of the bottom plate 2, and the second side wall 22b is not configured to be welded to another bottom plate 2. The first side wall 22a has a set width W₂ (a dimension along the direction Z), and the second side wall 22b also has a set width W₃ (a dimension along the direction Z), where 2W₂>W₃. In this way, since a sum of the widths W₂ of the two adjacent first side walls 22a is large, during the welding, a width of a meltable connection region between the two adjacent bottom plates 2 is large, a width of a welded structure formed between the two adjacent bottom plates 2 after the welding is larger, structural strength of the welded structure between the two adjacent bottom plates 2 is higher, and a possibility of a structural problem such as cracking, breakage, or bending of the welded structure between the two adjacent bottom plates 2 is low. Accordingly, the structural plate formed by welding at least two bottom plates 2 has higher operational reliability.

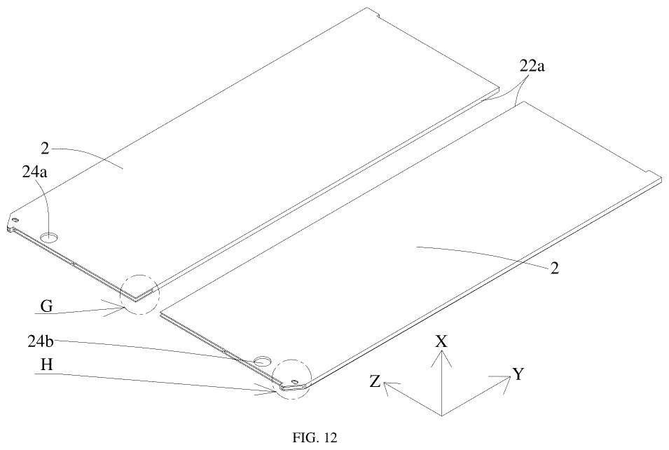

Referring to FIG. 12, if the structural plate at the bottom of the battery box 10 is formed by two bottom plates 2, each bottom plate 2 includes a first side wall 22a and a second side wall 22b spaced apart. The two first side walls 22a are welded, the second side wall 22b is not configured for welding, and the fourth cavity 21a is located between the first side wall 22a and the second side wall 22b. Referring to FIG. 13, if the structural plate at the bottom of the battery box 10 is formed by at least three bottom plates 2, the at least three bottom plates 2 are distributed along a width direction (a direction parallel to the direction Z) of the battery box 10. The outermost bottom plate 2 may include a first side wall 22a and a second side wall 22b spaced apart, and the corresponding fourth cavity 21a is located between the first side wall 22a and the second side wall 22b. The bottom plate 2 located between the two bottom plates 2 includes two first side walls 22a spaced apart, and the corresponding fourth cavity 21a is located between the two first side walls 22a. The two first side walls 22a between each two adjacent bottom plates 2 are welded, and the second side walls 22b are not configured for welding.

In other embodiments (not shown), the at least three bottom plates 2 are distributed along a length direction (a direction parallel to the direction Y) of the battery box 10.

In some embodiments, referring to FIG. 8, 3 mm≤W₃≤28 mm. The width W₃ may be, for example, 3 mm, 4 mm, 5 mm, 6 mm, 7 mm, or 8 mm.

Referring to FIG. 8, if the width W₃ of the second side wall 22b is less than 3 mm, the width of the second side wall 22b is excessively small, and the second side wall 22b has lower structural strength and is prone to structural problems such as cracking, fracture, or bending deformation. If the width W₃ of the second side wall 22b is greater than 10 mm, the width of the second side wall 22b is excessively large. When a dimension of the single bottom plate 2 along the direction Z is limited and a distance between the second side wall 22b and the first side wall 22a is limited, a dimension of the fourth cavity 21a along the direction Z is relatively small, and the fourth cavity 21a can accommodate a relatively small amount of the coolant, resulting in poor heat dissipation efficiency. Therefore, the width W₂ of the first side wall 22a is better within the range of 3 mm to 8 mm.

In some embodiments, referring to FIG. 10, 7 mm≤W₂≤10 mm. The width W₂ may be, for example, 7 mm, 8 mm, 9 mm, or 10 mm.

Referring to FIG. 10, if the width W₂ of the first side wall 22a is less than 7 mm, the width of the first side wall 22a is excessively small, a portion of the welded structure configured to form the bottom plate 2 has a smaller width, the formed welded structure has lower structural strength, and the formed welded structure is prone to structural problems such as cracking, fracture, or bending deformation. If the width W₂ of the first side wall 22a is greater than 10 mm, the width of the first side wall 22a is excessively large. When a dimension of the single bottom plate 2 along the direction Z is limited, the dimension of the fourth cavity 21a along the direction Z is relatively small, and the fourth cavity 21a can accommodate a relatively small amount of coolant, resulting in poor heat dissipation efficiency. Therefore, the width W₂ of the first side wall 22a is better within the range of 7 mm to 10 mm.

In some embodiments, referring to FIG. 10, the bottom plate 2 further includes a second top wall 23a and a second bottom wall 23b, the second top wall 23a is connected to the second bottom wall 23b through the first side wall 22a and the second side wall 22b, and the second top wall 23a, the first side wall 22a, and the second bottom wall 23b are at least part of a structure configured to define the fourth cavity 21a. In this way, the bottom plate 2 has a less complex structure and is easy to manufacture.

If the structural plate at the bottom of the battery box 10 is formed by two bottom plates 2, each bottom plate 2 further includes a second side wall 22b spaced apart from the first side wall 22a, and the second top wall 23a is also connected to the second bottom wall 23b through the second side wall 22b. The second top wall 23a, the first side wall 22a, the second bottom wall 23b, and the second side wall 22b serve as a structure configured to define the fourth cavity 21a.

If the structural plate at the bottom of the battery box 10 is formed by at least three bottom plates 2, the outermost bottom plate 2 also includes a second side wall 22b spaced apart from the first side wall 22a, the second top wall 23a is also connected to the second bottom wall 23b through the second side wall 22b, and the second top wall 23a, the first side wall 22a, the second bottom wall 23b, and the second side wall 22b serve as a structure configured to define the corresponding fourth cavity 21a. The bottom plate 2 located between two bottom plates 2 includes two first side walls 22a spaced apart, the second top wall 23a is connected to the second bottom wall 23b through the two first side walls 22a spaced apart, and the first side wall 22a, the second bottom wall 23b, and the two second side walls 22b serve as a structure configured to define the corresponding fourth cavity 21a.

The second top wall 23a is configured to fix and support the battery (not shown), the battery box 10 may further include a thermally conductive adhesive arranged between the second top wall 23a and the battery, the second top wall 23a is connected to the battery through the thermally conductive adhesive, and the thermally conductive adhesive may quickly conduct the heat of the battery to the second top wall 23a.

In addition, the second top wall 23a may be made of metal, and has higher thermal conductivity. The second top wall 23a can quickly transfer heat to the coolant located in the fourth cavity 21a.

Moreover, the battery box may further include a heat absorbing layer (not shown) arranged in the second top wall 23a facing away from the second bottom wall 23b. The heat absorbing layer may be made of a carbo-nitriding layer, a nitro-oxidizing layer, a carbo-oxidizing layer, or a carbo-nitro-oxidizing layer. Any of the above materials may make at least part of the heat absorbing layer in black or a dark color close to black. Compared with other colors (such as a silver-white color of stainless steel or aluminum), the heat absorbing layer with an appearance in black or a dark color close to black absorbs thermal radiation electromagnetic waves more efficiently, and the heat radiation electromagnetic waves that the heat absorbing layer can absorb has a large frequency range. Therefore, the heat absorbing layer can quickly and massively absorb the thermal radiation electromagnetic waves generated by the battery during operation. That is, the heat absorbing layer quickly absorbs the heat of the battery by using a principle of thermal radiation, and the second top wall 23a in contact with the heat absorbing layer transfers the heat absorbed by the heat absorbing layer to the coolant located in the fourth cavity 21a.

In some embodiments, referring to FIG. 10, a first chamfered portion 221 is included at a connection between a side of any one of the first side walls 22a facing away from the adjacent first side wall 22a and the corresponding second top wall 23a. The arrangement of the first chamfered portion 221 can reduce stress concentration at the connection between the first side wall 22a and the second top wall 23a, and reduce a possibility of structural problems such as cracking, breakage, or deformation occurring at the connection between the first side wall 22a and the second top wall 23a.

In some embodiments, referring to FIG. 10, a second chamfered portion 222 is included at a connection between a side of any one of the first side walls 22a facing away from the adjacent first side wall 22a and the corresponding second bottom wall 23b. The arrangement of the second chamfered portion 222 can reduce stress concentration at the connection between the first side wall 22a and the second bottom wall 23b, and reduce a possibility of structural problems such as cracking, breakage, or deformation occurring at the connection between the first side wall 22a and the second bottom wall 23b.

In some embodiments, referring to FIG. 10, the first chamfered portion 221 has a chamfered circle structure, and the first chamfered portion 221 has a set radius R₁, where 1 mm≤R₁≤3 mm. The radius R₁ may be, for example, 1 mm, 1.5 mm, 2 mm, 2.5 mm, or 3 mm.

Referring to FIG. 10, if the radius R₁ is less than 1 mm, the radius R₁ of the first chamfered portion 221 is smaller. On the one hand, stress concentration at the connection between the first side wall 22a and the second top wall 23a is higher, and the connection between the first side wall 22a and the second top wall 23a is prone to structural problems such as cracking, fracture, or deformation. On the other hand, when dimensional accuracy is ensured, it is more difficult to manufacture the first chamfered portion 221 with a smaller radius R₁. If the radius R₁ is greater than 3 mm, the radius R₁ of the first chamfered portion 221 is greater, and a volume of the connection between the first side wall 22a and the second top wall 23a is relatively large. When the volume of a single bottom plate 2 remains unchanged, the volume of the fourth cavity 21a is relatively small, and the fourth cavity 21a can accommodate a small amount of coolant, resulting in poor heat dissipation efficiency. Therefore, the radius R₁ is better within the range of 1 mm to 3 mm.

In other embodiments (not shown), the first chamfered portion 221 may have a right angle-chamferd structure.

In some embodiments, referring to FIG. 10, the second chamfered portion 222 has a chamfered circle structure, and the second chamfered portion 222 has a set radius R₂, where 1 mm≤R₂≤3 mm. The radius R₂ may be, for example, 1 mm, 1.5 mm, 2 mm, 2.5 mm, or 3 mm.

Referring to FIG. 10, if the radius R₂ is less than 1 mm, the radius R₂ of the second chamfered portion 222 is smaller. On the one hand, stress concentration at the connection between the first side wall 22a and the second bottom wall 23b is higher, and the connection between the first side wall 22a and the second bottom wall 23b is prone to structural problems such as cracking, fracture, or deformation. On the other hand, when dimensional accuracy is ensured, it is more difficult to manufacture the second chamfered portion 222 with a smaller radius R₂. If the radius R₂ is greater than 3 mm, the radius R₂ of the second chamfered portion 222 is greater, and a volume of the connection between the first side wall 22a and the second bottom wall 23b is relatively large. When the volume of a single bottom plate 2 remains unchanged, the volume of the fourth cavity 21a is relatively small, and the fourth cavity 21a can accommodate a small amount of coolant, resulting in poor heat dissipation efficiency. Therefore, the radius R₂ is better within the range of 1 mm to 3 mm.

In other embodiments (not shown), the second chamfered portion 222 may have a right angle-chamferd structure.

In some embodiments, referring to FIG. 10, there is a set height H₂ between the second top wall 23a and the second bottom wall 23b, where 5 mm≤H₂≤38 mm. The height H₂ may be, for example, 5 mm, 5.5 mm, 6 mm, 6.5 mm, 7 mm, 7.5 mm, or 8 mm.

Referring to FIG. 10, if the height H₂ is less than 5 mm, a height of the fourth cavity 21a located between the second top wall 23a and the second bottom wall 23b is relatively small, and the fourth cavity 21a can accommodate a small amount of coolant, resulting in poor heat dissipation efficiency. If the height H₂ is greater than 8 mm, a thickness of the bottom plate 2 is relatively large, the weight of the battery box 10 is also relatively large, and the transportation of the battery box 10 consumes more energy. Therefore, the height H₂ is better within the range of 5 mm to 8 mm.

In some embodiments, referring to FIG. 10, the bottom plate 2 further includes a support portion 22c located in the fourth cavity 21a, and the second bottom wall 23b is connected to the second top wall 23a through the support portion 22c. In this way, the support portion 22c plays a role in improving structural strength of the bottom plate 2, and the second top wall 23a and the second bottom wall 23b are less likely to have structural problems such as bending deformation, cracking, or breakage.

The support portion 22c may be in a shape of a rod, a column, a plate, or a disc. The following is mainly based on the plate-like support portion 22c. The number of the support portion 22c is not limited in some embodiments of the present disclosure.

In some embodiments, referring to FIG. 10, the support portion 22c has a set height H₃ (a dimension parallel to the direction X), where 5 mm≤H₃≤8 mm. The height H₃ may be, for example, 5 mm, 5.5 mm, 6 mm, 6.5 mm, 7 mm, 7.5 mm, or 8 mm.

Referring to FIG. 10, the height H₂ between the second top wall 23a and the second bottom wall 23b is the same as the height H₃ of the support portion 22c, and the technical effects brought about by the setting of the numerical range of the height H₃ include the technical effects brought about by the setting of the numerical range of the height H₂ described above, which are not described in detail herein again.

In some embodiments, referring to FIG. 10, the support portion 22c has a set width W₄ (a dimension parallel to the direction Z), where 3 mm≤W₄≤5 mm. The width W₄ may be, for example, 3 mm, 3.5 mm, 4 mm, 4.5 mm, or 5 mm.

Referring to FIG. 10, if the width W₄ of the support portion 22c is less than 3 mm, structural strength of the support portion 22c is lower, the support portion 22c is less effective in improving the structural strength of the bottom plate 2, and the second top wall 23a and the second bottom wall 23b are more likely to have the structural problems such as bending deformation, cracking, or breakage. If the width W₄ of the support portion 22c is greater than 5 mm, the support portion 22c occupies a relatively large space of the fourth cavity 21a, such that the fourth cavity 21a can accommodate a relatively small amount of coolant, resulting in poor heat dissipation efficiency. Therefore, the width W₄ of the support portion 22c is better within the range of 3 mm to 5 mm.

In some embodiments, referring to FIG. 10, a third chamfered portion 223 is included at a connection between the support portion 22c and the second top wall 23a. The arrangement of the third chamfered portion 223 can reduce stress concentration at the connection between the support portion 22c and the second top wall 23a, and reduce a possibility of structural problems such as cracking, breakage, or deformation occurring at the connection between the support portion 22c and the second top wall 23a.

In some embodiments, referring to FIG. 10, a fourth chamfered portion 224 is included at a connection between the support portion 22c and the second bottom wall 23b. The arrangement of the fourth chamfered portion 224 can reduce stress concentration at the connection between the support portion 22c and the second bottom wall 23b, and reduce a possibility of structural problems such as cracking, breakage, or deformation occurring at the connection between the support portion 22c and the second bottom wall 23b.

In some embodiments, referring to FIG. 10, the third chamfered portion 223 has a chamfered circle structure, and the third chamfered portion 223 has a set radius R₃, where 1 mm≤R₃≤3 mm. The radius R₃ may be, for example, 1 mm, 1.5 mm, 2 mm, 2.5 mm, or 3 mm.

Referring to FIG. 10, if the radius R₃ is less than 1 mm, the radius R₃ of the third chamfered portion 223 is smaller. On the one hand, stress concentration at the connection between the support portion 22c and the second top wall 23a is higher, and the connection between the support portion 22c and the second top wall 23a is prone to structural problems such as cracking, fracture, or deformation. On the other hand, when dimensional accuracy is ensured, it is more difficult to manufacture the third chamfered portion 223 with a smaller radius R₃. If the radius R₃ is greater than 3 mm, the radius R₃ of the third chamfered portion 223 is greater, and a volume of the connection between the support portion 22c and the second top wall 23a is relatively large. When the volume of a single bottom plate 2 remains unchanged, the volume of the fourth cavity 21a is relatively small, and the fourth cavity 21a can accommodate a small amount of coolant, resulting in poor heat dissipation efficiency. Therefore, the radius R₃ is better within the range of 1 mm to 3 mm.

In other embodiments (not shown), the third chamfered portion 223 has a right angle-chamferd structure.

In some embodiments, referring to FIG. 10, the fourth chamfered portion 224 has a chamfered circle structure, and the fourth chamfered portion 224 has a set radius R₄, where 1 mm≤R₄≤3 mm. The radius R₄ may be, for example, 1 mm, 1.5 mm, 2 mm, 2.5 mm, or 3 mm.

Referring to FIG. 10, if the radius R₄ is less than 1 mm, the radius R₄ of the fourth chamfered portion 224 is smaller. On the one hand, stress concentration at the connection between the support portion 22c and the second bottom wall 23b is higher, and the connection between the support portion 22c and the second bottom wall 23b is prone to structural problems such as cracking, fracture, or deformation. On the other hand, when dimensional accuracy is ensured, it is more difficult to manufacture the fourth chamfered portion 224 with a smaller radius R₄. If the radius R₄ is greater than 3 mm, the radius R₄ of the fourth chamfered portion 224 is greater, and a volume of the connection between the support portion 22c and the second bottom wall 23b is relatively large. When the volume of a single bottom plate 2 remains unchanged, the volume of the fourth cavity 21a is relatively small, and the fourth cavity 21a can accommodate a small amount of coolant, resulting in poor heat dissipation efficiency. Therefore, the radius R₄ is better within the range of 1 mm to 3 mm.

In other embodiments (not shown), the fourth chamfered portion 224 has a right angle-chamferd structure.

In some embodiments, referring to FIG. 11, the support portion 22c has a plate-like structure, and the fourth cavity 21a is separated by the support portion 22c to form at least two parallel and communicated flow channels 21. In this way, the flow channel 211 is configured to guide the coolant to flow in an orderly manner along an extension direction (a direction parallel to the direction Y) of the flow channel 211 to improve circulation efficiency of the coolant. Secondly, the flow channel 211 is further configured to separate the coolant to form at least two streams of fluid flowing separately, and each stream of fluid is used to absorb heat of a corresponding part in the bottom plate 2. There is little difference between efficiency of heat transfer by each part of the bottom plate 2 to the coolant. Therefore, the arrangement of the flow channel 211 can improve the heat dissipation efficiency.

If there are a larger number of support portions 22c, a larger number of flow channels 211 are formed.

In some embodiments, a cross section of the flow channel 211 is in a shape of a rectangle (as shown in FIG. 10), a circle, a semicircle, an ellipse, or a hexagon. The flow channel 211 with the cross section in any one of the above shapes can meet a requirement for circulation of the coolant.

In some embodiments, referring to FIG. 11, the bottom plate 2 further includes at least two partitions 22d located in a same flow channel 211, the partition 22d is parallel to the plate-like support portion 22c, and the partitions 22d located in the same flow channel 211 are spaced apart along a flow guiding direction (a direction parallel to the direction Y) of the flow channel 211.

Referring to FIG. 11, when the coolant flows in the flow channel 211, it is easy to form a plurality of stratospheres that are stacked and arranged along the flow guiding direction of the flow channel 211, and the stratosphere in the coolant close to the support portion 22c easily absorbs the heat of the support portion 22c, or the stratosphere in the coolant close to the second top wall 23a easily absorbs the heat of the second top wall 23a. However, heat transfer efficiency between the stratospheres is poor, and it is difficult to transfer the heat to the inner stratosphere in the coolant, resulting in poor heat dissipation efficiency. However, the arrangement of two adjacent partitions 22d at intervals can easily cause the coolant to form turbulent flow in an interval space between the two adjacent partitions 22d. The turbulent flow can break the stratosphere of the coolant and redistribute the heat in the coolant, that is, the heat outside the coolant is more easily transferred to the inside of the coolant, thereby improving the heat dissipation efficiency.

A height of the partition 22d may be smaller than the height H₂ of the fourth cavity 21a or the height H₃ of the support portion 22c, and the partition 22d may be connected only to the second top wall 23a or the partition 22d may be connected only to the second bottom wall 23b. The height of the partition 22d may be equal to the height H₂ of the fourth cavity 21a or the height H₃ of the support portion 22c. For example, the partition 22d is connected to the second top wall 23a, and the partition 22d is also connected to the second bottom wall 23b. A width (a dimension along the direction Z) of the partition 22d is smaller than a width (a dimension along the direction Z) of the flow channel 211. A ratio of the width of the partition 22d to the width of the flow channel 211 is in a range of 1:10 to 2:10. A length (a dimension along the direction Y) of the partition 22d is smaller than a length (a dimension along the direction Y) of the support portion 22c. A ratio of the length of the partition 22d to the length of the support portion 22c is in a range of 1:20 to 2:20.

In addition, neither the position of the partition plate 22d along the direction Z nor the position along the direction Y in the flow channel 211 is limited.

In some embodiments, referring to FIG. 12, the bottom plates 2 are distributed along the width direction (the direction parallel to the direction Z) of the battery box 10, the fourth cavities 21a of the bottom plates 2 are in communication with each other, one of the outermost bottom plates 2 is provided with a liquid inlet 24a, and the other of the outermost bottom plates 2 is provided with a liquid outlet 24b. In this way, the coolant outside the bottom plate 2 can flow into the fourth cavity 21a of the corresponding bottom plate 2 from the liquid inlet 24a of one of the outermost bottom plates 2. The fourth cavities 21a of the bottom plates 2 are sequentially in communication with each other to form a cooling passage that guides one-way flow of the coolant. The coolant may pass through the fourth cavities 21a one by one, and the coolant may flow from the fourth cavity 21a of the other of the outermost bottom plates 2 to the outside of the bottom plate 2 through the corresponding liquid outlet 24b. In this way, the coolant flows unidirectionally from the liquid inlet 24a to the liquid outlet 24b, and it is less difficult to control the coolant to flow.

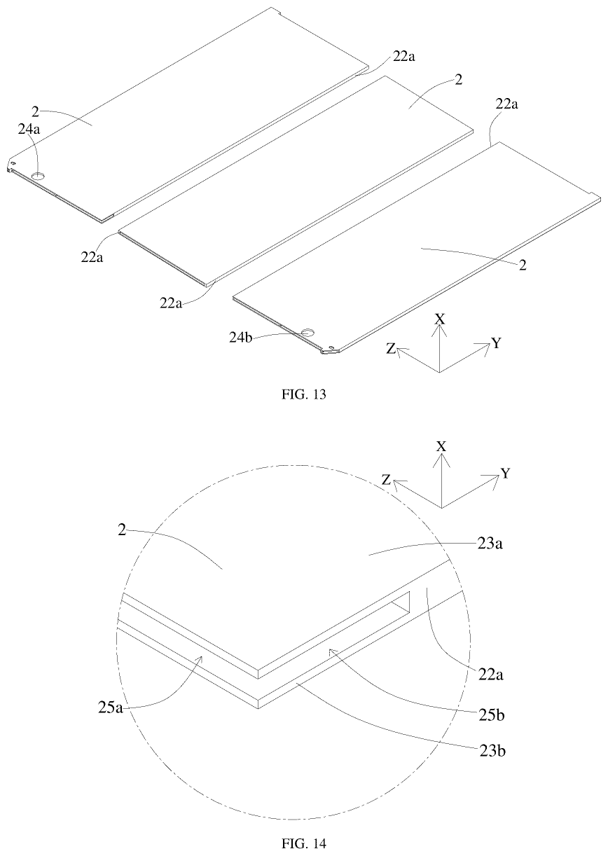

Referring to FIG. 11 and FIG. 14, each bottom plate 2 is provided with a sixth opening 25b communicating with the fourth cavity 21a, and the sixth openings 25b of every two adjacent and welded bottom plates 2 are in communication with each other. That is, the coolant located in the fourth cavity 21a of one of the bottom plates 2 may flow to the fourth cavity 21a of the other of the bottom plates 2 through the sixth opening 25b. The second top wall 23a, the first side wall 22a, and the second bottom wall 23b define the sixth opening 25b.

In other embodiments (not shown), the bottom plates 2 may be distributed along the length direction (the direction parallel to the direction Y) of the battery box 10.

In some embodiments, referring to FIG. 2, the battery box 10 further includes a liquid inlet connecting pipe 6, the liquid inlet connecting pipe 6 is in communication with the liquid inlet 24a as shown in FIG. 12, and the liquid inlet connecting pipe 6 is configured to be in communication with a corresponding external flow guiding pipe (not shown). In this way, the coolant can flow into the fourth cavity 21a of the bottom plate 2 from the external flow guiding pipe sequentially through the liquid inlet connecting pipe 6 and the liquid inlet 24a. The liquid inlet connecting pipe 6 is sealingly connected (e.g., welded or sealed with sealant) to the bottom plate 2 provided with the liquid inlet 24a, to reduce a possibility of leakage of the coolant between the liquid inlet connecting pipe 6 and the bottom plate 2.

In some embodiments, referring to FIG. 2, the battery box 10 further includes a liquid outlet connecting pipe 7, the liquid outlet connecting pipe 7 is in communication with the liquid outlet 24b as shown in FIG. 12, and the liquid outlet connecting pipe 7 is configured to be in communication with a corresponding external flow guiding pipe (not shown). In this way, the coolant can flow into the external flow guiding pipe from the fourth cavity 21a of the bottom plate 2 sequentially through the liquid outlet connecting pipe 7 and the liquid outlet 24b. The liquid outlet connecting pipe 7 is sealingly connected (e.g., welded or sealed with sealant) to the bottom plate 2 provided with the liquid outlet 24b, to reduce a possibility of leakage of the coolant between the liquid outlet connecting pipe 7 and the bottom plate 2.

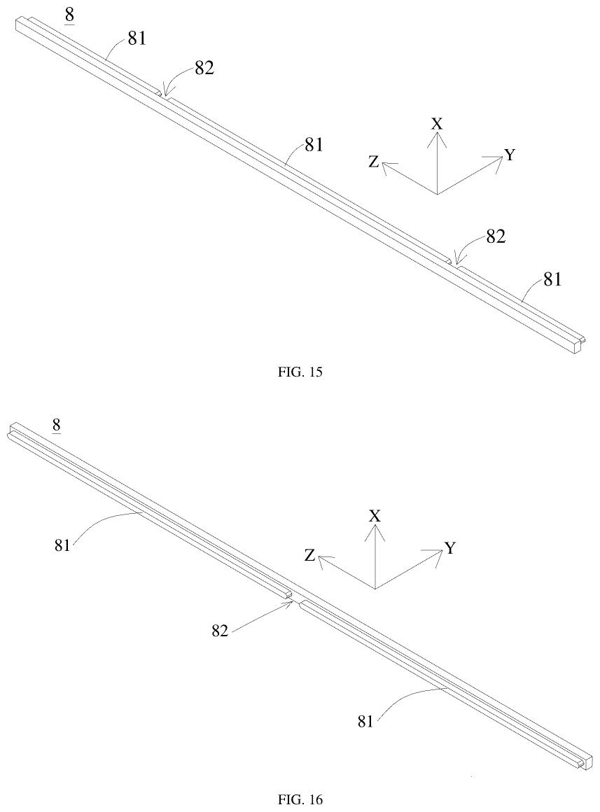

In some embodiments, as shown in FIG. 14, the bottom plate 2 is provided with a fifth opening 25a in communication with the fourth cavity 21a. The arrangement facilitates the manufacturing of the bottom plate 2 provided with the fifth opening 25a and the fourth cavity 21a by using an extrusion molding process. Referring to FIG. 15 to FIG. 16, the battery box 10 may further include a first blocking member 8. The first blocking member 8 is configured to block the fifth opening 25a. The first blocking member 8 has a blocking effect on the coolant located in the fourth cavity 21a, reducing a possibility of leakage of the coolant to the outside of the bottom plate 2 through the fifth opening 25a.

The first blocking member 8 may be welded to the bottom plate 2 or bonded with sealant.

In addition, fifth openings 25a are provided at two opposite ends of the bottom plate 2 along the direction X, the battery box 10 includes two first blocking members 8, and each first blocking member 8 blocks the corresponding fifth opening 25a.

Moreover, referring to FIG. 15 to FIG. 16, the first blocking member 8 includes at least two protruding portions 81 spaced apart along the direction Z. The protruding portions 81 pass through and block the fifth opening 25a. A height of the protruding portion 81 along the direction X is the same as the height H2 of the fourth cavity 21a along the direction X.

Referring to FIG. 15 to FIG. 16, an interval space 82 is provided between every two protruding portions 81. The numbers of the protruding portion 81 and the interval space 82 are not limited in some embodiments of the present disclosure. A certain interval space 82 is embedded in the support portion 22c, such that a certain support portion 22c is connected to a certain protruding portion 81. A certain interval space 82 is embedded in the first side wall 22a, such that a certain first side wall 22a is connected to a certain protruding portion 81. The above arrangement further increases reliability of the connection between the first blocking member 8 and the bottom plate 2. Further, each first blocking member 8 is connected to at least two bottom plates 2 to further improve the structural strength of the structural plate formed by at least two bottom plates 2.

A certain fifth opening 25a is connected to the sixth opening 25b. Correspondingly, a certain protruding portion 81 also passes through the sixth opening 25b, but the sixth opening 25b is not blocked by the protruding portion 81.

In some embodiments, referring to FIG. 8, the outermost bottom plate 2 may also include a third side wall 22e spaced apart from the second side wall 22b. That is, the second side wall 22b is located between the first side wall 22a and the third side wall 22e, and the second top wall 23a is also connected to the second bottom wall 23b through the third side wall 22e. The second top wall 23a, the third side wall 22e, the second bottom wall 23b, and the second side wall 22b define a fifth cavity 21b provided in the outermost bottom plate 2. In this way, the weight of the outermost bottom plate 2 is smaller. Correspondingly, the weight of the battery box 10 is also smaller, and less energy is required to transport the battery box 10.

Referring to FIG. 11, the fifth cavity 21b is arranged along the direction Y.

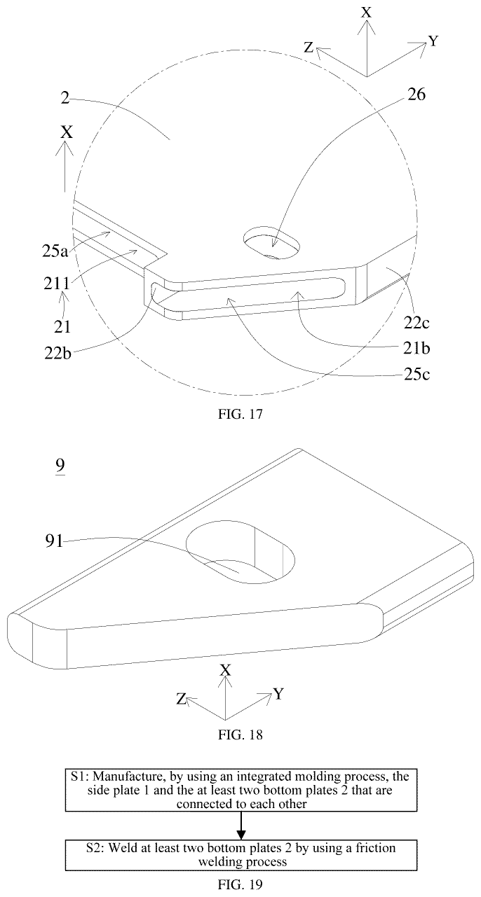

In some embodiments, referring to FIG. 17, the outermost bottom plate 2 is further provided with a seventh opening 25c in communication with the fifth cavity 21b. Referring to FIG. 18, the battery box 10 may further include a second blocking member 9. The second blocking member 9 blocks the seventh opening 25c. Correspondingly, at least part of the second blocking member 9 is located in the fifth cavity 21b. The outermost bottom plate 2 is further provided with a first through hole 26 running through the second top wall 23a and the second bottom wall 23b. When the second blocking member 9 does not block the seventh opening 25c, the first through hole 26 can still be communication with the fifth cavity 21b. The second blocking member 9 is further provided with a second through hole 91. When the second blocking member 9 blocks the seventh opening 25c and at least part of the second blocking member 9 is located in the fifth cavity 21b, the second through hole 91 is in communication with the first through hole 26, thereby forming holes that can play a positioning or connecting role. The connection between the second blocking member 9 and the bottom plate 2 can enhance structural strength of a part of the bottom plate 2 where the first through hole 26 is provided.

In some embodiments, referring to FIG. 4, the outermost bottom plate 2 and the side plate 1 are integrally connected or welded.

If the outermost bottom plate 2 and the side plate 1 are integrally formed and connected (e.g., integrally formed and manufactured by a casting process, an extrusion molding process, or an injection molding process), there are advantages of reducing a number of manufactured molds, improving manufacturing efficiency, and improving structural strength and dimensional accuracy between the outermost bottom plate 2 and the side plate 1.

Referring to FIG. 19, in a second aspect of some embodiments of the present disclosure, a manufacturing method for a battery box is provided. Referring to FIG. 2, the battery box 10 manufactured includes two side plates 1 and at least two bottom plates 2. The bottom plates 2 are distributed along the width direction (parallel to the direction Z) of the battery box 10. The outermost bottom plate 2 is connected to the corresponding side plate 1. The manufacturing method for a battery box provided in some embodiments of the present disclosure includes the following steps.

In step S1, the side plates 1 and the bottom plates 2 are manufactured by using an integrated molding process.

In step S2, the at least two bottom plates 2 are welded by using a friction welding process.

The outermost bottom plate 2 and the side plate 1 connected to each other as shown in FIG. 4 are manufactured by using the integrated molding process. The integrated molding process has advantages of reducing a number of manufactured molds, improving manufacturing efficiency, and improving structural strength and dimensional accuracy between the outermost bottom plate 2 and the side plate 1. The integrated molding process may be a casting process, an extrusion molding process, or an injection molding process.

First side walls 22a of the at least two bottom plates 2 as shown in FIG. 10 are welded by using the friction welding process. In detail, a temperature of the first side wall 22a of the bottom plate 2 is increased by high-speed friction until at least part of the first side wall 22a melts, molten portions of the first side walls 22a of the two bottom plates 2 are then welded, and after the first side walls 22a are cooled, a welded structure is formed between the first side walls 22a of the two bottom plates 2. Since no other material is required to assist the welding during the welding, the material of the welded structure between the first side walls 22a of the two bottom plates 2 is the same as that of the bottom plate 2, that is, structural strength of the welded structure between the first side walls 22a of the two bottom plates 2 is the same as that of the bottom plate 2, and the formed structural plate located at the bottom of the battery box 10 has higher operational reliability.

The first side walls 22a of the two bottom plates 2 may rub against each other at a high speed, or curved side walls of a high-speed rotating cylinder may be used to simultaneously rub the first side walls 22a of the two bottom plates 2 until at least part of the first side walls 22a of the two bottom plates 2 are molten, and then molten portions of the first side walls 22a of the two bottom plates 2 are welded.

What is claimed is:

1. A battery box, comprising at least two bottom plates welded to each other, wherein
each bottom plate of the at least two bottom plates is provided with a respective fourth cavity, the fourth cavity is configured to circulate coolant, each bottom plate of the at least two bottom plates comprises a first side wall welded to an adjacent bottom plate, the first side wall has a set width W₂, an outermost bottom plate comprises a second side wall spaced apart from the first side wall, and
the second side wall has a set width W₃, where 2W₂>W₃; wherein 7 mm≤W₂≤10 mm, or 3 mm≤W₃≤8 mm.

2. The battery box according to claim 1, wherein
each bottom plate of the at least two bottom plates further comprises a second top wall and a second bottom wall, the second top wall is connected to the second bottom wall through the first side wall and the second side wall, wherein
the second top wall, the first side wall, and the second bottom wall are at least part of a structure that defines the fourth cavity, and wherein
a first chamfered portion is provided at a connection between a side of any one of first side walls facing away from an adjacent first side wall and a corresponding second top wall, and/or
a second chamfered portion is provided at a connection between a side of any one of first side walls facing away from an adjacent first side wall and a corresponding second bottom wall.

3. The battery box according to claim 2, wherein
the first chamfered portion has a chamfered circle structure and a set radius R₁, where 1 mm≤R₁≤3 mm, and/or
the second chamfered portion has a chamfered circle structure and a set radius R₂, where 1 mm≤R₂≤3 mm.

4. The battery box according to claim 2, wherein
a height H₂ is set between the second top wall and the second bottom wall, where 5 mm≤H₂<8 mm.

5. The battery box according to claim 2, wherein
each bottom plate of the at least two bottom plates further comprises a support portion located in the fourth cavity, and the second bottom wall is connected to the second top wall through the support portion.

6. The battery box according to claim 5, wherein the support portion has a plate-like structure, and the fourth cavity is separated by the support portion to form at least two flow channels that are parallel to and in communication with each other.

7. The battery box according to claim 6, wherein
a cross section of each flow channel of the at least two flow channels has a shape of a rectangle, a circle, a semicircle, an ellipse, or a hexagon.

8. The battery box according to claim 6, wherein
each bottom plate of the at least two bottom plates further comprises at least two partitions located in a same flow channel of the at least two flow channels, each partition of the at least two partitions is parallel to the support portion that has the plate-like structure, and
the at least two partitions located in the same flow channel are spaced apart from each other along a flow guiding direction of the same flow channel.

9. The battery box according to claim 1, wherein
the at least two bottom plates are distributed along a width direction or a length direction of the battery box, the fourth cavities of the at least two bottom plates are in communication with each other, one of outermost bottom plates is provided with a liquid inlet, and another of the outermost bottom plates is provided with a liquid outlet,
the battery box further comprises a liquid inlet connecting pipe and a liquid outlet connecting pipe, wherein the liquid inlet connecting pipe is in communication with the liquid inlet, and the liquid inlet connecting pipe is sealingly connected to a bottom plate of the at least two bottom plates provided with the liquid inlet,
the liquid outlet connecting pipe is in communication with the liquid outlet, and the liquid outlet connecting pipe is sealingly connected to a bottom plate of the at least two bottom plates provided with the liquid outlet, and
the liquid inlet connecting pipe and the liquid outlet connecting pipe are configured to be in communication with corresponding external flow guiding pipes.

10. The battery box according to claim 1, wherein
each bottom plate of the at least two bottom plates is provided with a fifth opening in communication with the fourth cavity, and the battery box further comprises a first blocking member blocking the fifth opening.

11. The battery box according to claim 1, wherein the battery box further comprises a side plate, the at least two bottom plates are distributed along a width direction or a length direction of the battery box, and an outermost bottom plate and the side plate are integrally formed or welded to each other, and
the side plate is provided with a sliding groove that is inwardly concaved, the sliding groove is configured to be in sliding fit with a slide rail, and a side wall of the side plate configured to define the sliding groove is provided with a hoisting hole, wherein the hoisting hole is configured to be passed through by a hook, such that the side plate is configured to connect the hook.

12. The battery box according to claim 11, wherein
the sliding groove is provided at an outer side wall of the side plate arranged along a height direction of the battery box, and
a top wall of the side plate configured to define the sliding groove is provided with the hoisting hole.

13. The battery box according to claim 12, wherein
a top of the side plate is further provided with a first cavity, the first cavity is in communication with the sliding groove through the hoisting hole, and
the first cavity is configured to accommodate at least part of the hook.

14. The battery box according to claim 13, wherein
a second cavity is further provided at a side of the side plate facing away from the sliding groove, and the side plate is further provided with a first opening, the first opening is in communication with the hoisting hole, the second cavity is in communication with the sliding groove through the first opening, and
the second cavity is in communication with the first cavity through the first opening.

15. The battery box according to claim 14, wherein
a third cavity is further provided at a bottom of the side plate, and the side plate is provided with a second opening, the second opening is in communication with the first opening, the second opening is further in communication with the sliding groove, the third cavity is in communication with the second cavity through the second opening, and
the third cavity is in communication with the sliding groove through the second opening.

16. The battery box according to claim 15, wherein
the outer side wall of the side plate is provided with a third opening, the third opening is in communication with the second opening, and the third opening is configured to avoid a bending portion outer arc surface of the hook.

17. The battery box according to claim 15, wherein
the side plate comprises an I-shaped rib which is configured to separate the side plate to form the first cavity, the second cavity, the third cavity, and the sliding groove, and
the hoisting hole, the first opening, and the second opening are arranged at the I-shaped rib.

18. The battery box according to claim 12, wherein
the outer side wall of the side plate is provided with a fourth opening, the fourth opening is in communication with the hoisting hole, and the fourth opening is configured to avoid a bending portion inner arc surface of the hook.

19. The battery box according to claim 11, wherein
the sliding groove has a set width W₁, where 10 mm≤W₁≤15 mm, and/or the sliding groove has a set depth H₁, where 8 mm≤H₁≤12 mm.

20. A method for manufacturing a battery box, wherein the battery box comprises a side plate and at least two bottom plates, and the method comprises:
manufacturing, using an integrated forming process, the side plate and the at least two bottom plates that are connected to each other; and
welding the at least two bottom plates by using a friction welding process.
